(19) United States
(12) Patent Application Publication
(10) Pub. No.: US 2013/0051449 A1
(43) Pub. Date: Feb. 28, 2013

(54) WIRELESS TRANSMISSION SYSTEM AND METHOD OF WIRELESSLY TRANSMITTING DIGITAL INFORMATION

(71) Applicant: Sebastian Georgi, Langenhagen (DE)

(72) Inventor: Sebastian Georgi, Langenhagen (DE)

(73) Assignee: Sennheiser electronic GmbH & Co. KG, Wedemark (DE)

(21) Appl. No.: 13/221,411

(22) Filed: Aug. 30, 2011

(51) Int. Cl. H04L 27/12; H04L 27/14; H04L 27/01

(52) U.S. Cl. 375/229; 375/303

(57) ABSTRACT

A wireless communication system is provided having a transmitter, having a modulation unit for performing a frequency shift keying modulation wherein an output of the modulation unit is bundled into data blocks. The communication system furthermore comprises a cyclic prefix adding unit for adding a cyclic prefix (CP) into each data block of an output of the modulation unit.

### DESCRIPTION OF RELATED ART

The present invention relates to a wireless transmission system and a method of wirelessly transmitting digital information, in particular audio signals.

### BRIEF SUMMARY OF THE INVENTION

The demand for wireless high data rate communication in mobile applications is still increasing. To achieve high data rates, current communication systems use mobile radio channels which fulfil the broadband property, that means the duration Tₛ of the modulation symbol is significantly smaller than the maximum path delay Tₘₐₓ. This behaviour has the advantage, that some frequency components of the transmit signal may be affected by destructive interference due to fast fading effects but not all of them. Compared to a narrowband channel the broadband channel introduces a kind of frequency diversity. The drawback of a broadband channel is the need for an equalization at the receiver side.

When a filter length of a time domain equalizer inside the receiver is greater than 20, its computational complexity outweighs the fast convolution (FC) in frequency domain. In a fast convolution the input signal is transferred into frequency domain using a discrete fourier transform (DFT), multiplied by the transfer function of the filter and converted back into time domain using the inverse DFT (IDFT). For a continuous data stream windowing functions and overlap and add techniques must be used, because the DFT operation assumes periodic input signals. Orthogonal Frequency-Division Multiplexing OFDM offers an alternative to cope with this DFT property by adding a cyclic prefix (CP) to the transmit signal. When transmit signal components arrive on a delaying propagation path at the receiver, parts of the cyclic prefix are moved into the DFT window. This timeshift results in a multiplication of the signal's spectrum with a complex exponential function only. It is a fundamental property of OFDM, that the length T_{G} of the cyclic prefix must be equal or larger than Tₘₐₓ.

It is therefore an object of the invention to provide an improved modulation system as well as an improved method for modulating digital information, in particular audio signals.

This object is solved by the modulation system according to claim 1.

Therefore, a transmission system having a transmitter and a receiver is provided. The transmitter comprises a modulating unit for performing a frequency shift keying modulation and a cyclic prefix adding unit for adding a cyclic prefix into the output of the modulation unit.

By introducing the cyclic prefix into the output of the FSK modulating unit, an equalization which needs to be performed in the receiver can be simplified and will demand less power consumption.

According to an aspect of the invention, each data frame of the output of the transmitter comprises a return to zero symbol as well as a cyclic prefix. The return to zero symbol ensures that the cyclic prefix remains cyclic even after a FM modulation.

The invention also relates to a method of wireless communication. For transmitting digital information, in particular audio signals, a frequency shift keying modulation is performed. The output of the modulation is bundled into data blocks. A cyclic prefix is added into each data block of the output of the modulation.

The invention is based on the idea that orthogonal frequency division multiplexing OFDM is well known for its efficient solution to the task of compensating the influence of a broadband channel with strong muitipath propagation using equalization in frequency domain. However the extremely high peak to average power ratio of OFDM modulated transmit signals and the demand of linearity inside the signal transmission chain results in a poor energy efficiency at the power amplifier.

According to the invention, a communication system for transmitting and receiving digital information, in particular audio signals, using FSK modulation and gaussian pulse shaping is applied to a broadband channel. Equalization at the receiver is done in frequency domain as known in OFDM. To simplify the equalization and according to the invention, a cyclic prefix and a return-to-zero symbol is added to the transmit signal also.

According to the invention, a novel transmission scheme is introduced. It will be shown, that according to the invention signals with constant envelope such as FSK modulated signals can also make use of an OFDM like equalization procedure with comparable BER performance.

According to the invention, digital information e.g. like audio signals, can be transmitted.

Further aspects of the invention are defined in the dependent claims.

### BRIEF DESCRIPTION OF THE DRAWINGS

Advantages and embodiments of the invention will now be described in more detail with reference to the figures.

FIG. 1 shows a block diagram of a transmission system in time domain according to a first embodiment,

FIG. 2 shows a block diagram of a transmission system according to a second embodiment,

FIG. 3 shows a block diagram of a transmission system according to a third embodiment,

FIG. 4 shows a basic arrangement of modulation symbols in the time domain according to a fourth embodiment,

FIG. 5 shows a graph depicting a power spectral density for one bit per symbol,

FIG. 6 shows a graph depicting a power spectral density for two bits per symbol,

FIG. 7 shows a graph depicting the bit error rate for an uncoded transmission with one bit per symbol,

FIG. 8 shows a graph depicting an uncoded bit error rate for an uncoded transmission with two bits per symbol,

FIGS. 9 and 10 each show a graph of a result of the transmission according to the invention, and

FIGS. 11 and 12 each show a graph depicting the bit area performance for one and two bits per symbol.

### DETAILED DESCRIPTION OF EMBODIMENTS

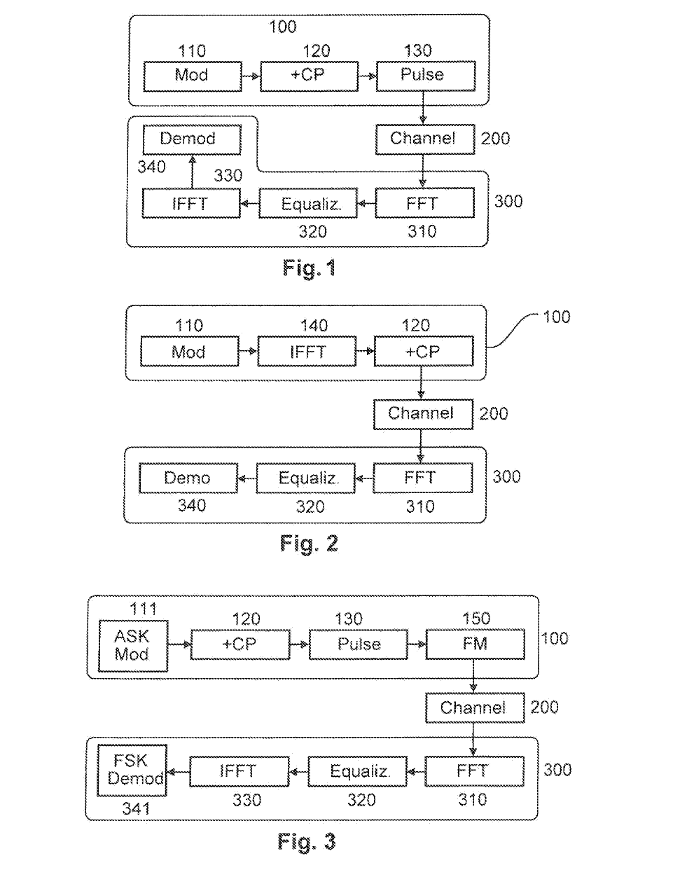

FIG. 1 shows a block diagram of a transmission or communication system for transmitting and receiving digital information, in particular audio signals, using fast convolution according to a first embodiment. The computational complexity is unbalanced between a transmitter 100 and a receiver 300. The transmitter 100 comprises a modulating unit 110, a cyclic prefix adding unit 120 and a pulse generating unit 130. The transmitter 100 adds a cyclic prefix CP by the cyclic prefix adding unit 120 only. The signal from the transmitter 100 is transmitted wirelessly over the channel 200 and received by the receiver 300. The receiver comprises a fast fourier transformation unit 310, an equalizing unit 320, an inverse fast fourier transformation unit 330 and a demodulating unit 340. The advantage of this approach is the possibility to use transmit signals with constant envelope such as FSK modulated signals. This transmission or communication scheme is well suited for transmitters with limited energy resources and small computational capabilities.

In particular, FIG. 1 depicts the system using a fast convolution FC equalizer for any modulation scheme.

OFDM balances the computational complexity by modulating the transmit signal in frequency domain and performing the IFFT on transmitter side.

FIG. 2 shows a block diagram of a transmission or communication system for transmitting and receiving digital information, in particular audio signals, according to a second embodiment. The transmission system according to the second embodiment comprises a transmitter 100 which wirelessly transmits via a wireless channel 200 to a wireless receiver 300. The transmitter comprises a modulation unit 110, an inverse fast fourier transformation unit 140 and a cyclic prefix adding unit 120. The receiver 300 comprises a fast fourier transformation unit 310, an equalizing unit 320 and a demodulation unit 340. On receiver side 300 the demodulation takes place in frequency domain also, avoiding the need for an IFFT operation. The modulation in frequency domain is the reason for an extremely high peak to average power ratio PAPR. Transmit signals having a high PAPR demand a linear power amplifier. Its effectiveness is upper bounded to 15% when a class-A amplifier is used and a PAPR of 12 dB in the RF domain is assumed. This makes the OFDM transmission technique unattractive for battery driven devices.

As shown in FIG. 1 any received signal can be equalized using fast convolution FC as long as a cyclic prefix CP is inserted. According to the invention, a transmit signal, which is modulated with frequency shift keying FSK is extended by a cyclic prefix CP. A detailed description of the system concept as well as its parameters are given below. Therefore a transmission of this signal over a broadband channel is feasible as long as a FC equalization takes place on the receiver side.

In the following, the frequency shift keying FSK modulated communication system is described in detail. Furthermore the system parameters of the FSK modulation as well as the reference OFDM implementation are given.

FIG. 3 shows a block diagram of a transmission system for FSK modulated transmit signals. The transmission system comprises a transmitter 100, a channel 200 and a receiver 300. The transmitter 100 comprises an amplitude shift keying ASK modulating unit 111, a cyclic prefix adding unit 120, a pulse generating unit 130 and a frequency modulation unit 150. The receiver 300 comprises a fast fourier transformation unit 310, an equalization unit 320, an inversed fast fourier transformation unit 330 and a frequency shift keying demodulation unit 341. On transmitter side 100 the information bits are modulated into symbols using an amplitude shift keying ASK by the ASK modulation unit 111. A conventional FSK transmitter uses a transmit pulse such as a gaussian pulse to smooth transitions between symbols. Therefore, the modulation scheme is called Gaussian FSK GFSK. This introduces the partial response property and improves the spectral efficiency drastically. Afterwards the pulse shaped and ASK modulated information stream is frequency modulated FM by the FM modulation unit 150 to the carrier frequency using for example a voltage controlled oscillator VCO. In this case no complex baseband signal vector is generated, the constant envelope property is preserved but time domain low pass filtering in the baseband for additional spectral shaping is not applicable. Nevertheless, expensive quadrature modulators (in terms of energy consumption and price) can be avoided.

As shown in FIG. 3 a cyclic prefix CP is included (by means of the cyclic prefix adding unit 120) to the ASK modulated information bits before pulse shaping takes place by the pulse shaping unit 130. Therefore, the ASK stream is fractionized into blocks of the equal length N−1. Due to the memory of the GFSK modulation a single symbol is necessary at the end of each block to reach the same phase state as the beginning of the block. This symbol is called return to zero RTZ symbol. It ensures, that the cyclic prefix CP is in fact a cyclic extension of the current block even after pulse shaping and FM modulation.

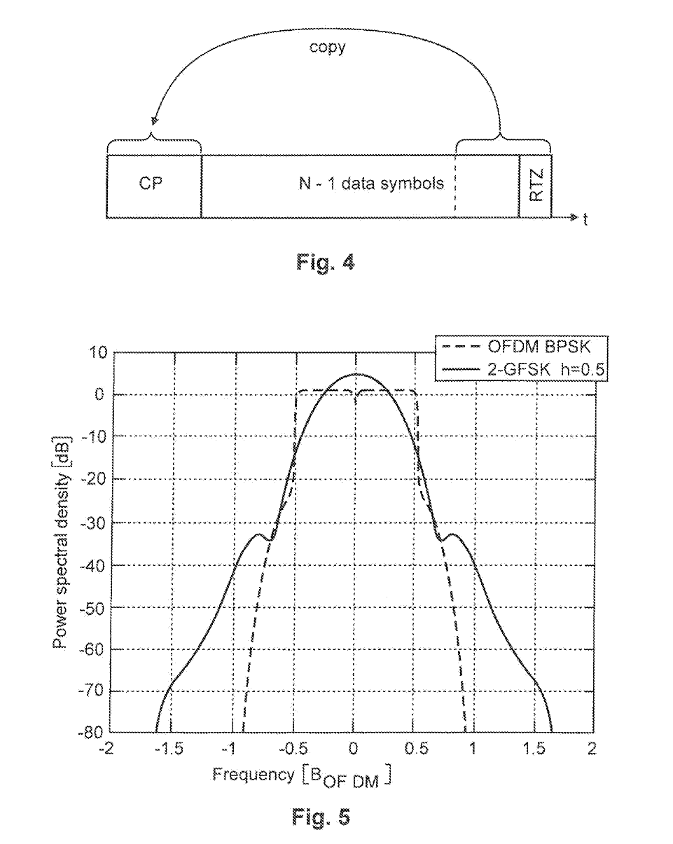

FIG. 4 shows an arrangement of modulation symbols in time domain. The length of the cyclic prefix CP corresponds to the maximum path delay of the mobile radio channel, however the length of the transmit pulse must also be added, because it adds inter symbol interference itself. To summarize, a transmit signal with constant envelope at the carrier frequency is generated which has the special property, that after a block of N symbols a fraction of that block is repeated before a new block is transmitted.

On receiver side the signal can be demodulated even after being transmitted over a multipath propagation channel as long as an equalization using fast convolution takes place. The equalization on the receiver side is similar to an OFDM receiver. Therefore a quadrature demodulator must be applied to the received signal to guarantee a linear signal processing. A nonlinear FM demodulator can be applied after the equalization in frequency domain and transformation back into time domain (see FIG. 3). To emulate a continuous stream for the Viterbi decoder inside the GFSK demodulator, the cyclic prefix of the equalized block is added again. Its content, as well as the RTZ symbol is removed after GFSK demodulation.

The OFDM transmit signal is composed of N−1 subcarriers and a zero carrier at the DC position. Therefore both the OFDM system and the GFSK approach provide exactly the same data rate. For simplicity reasons N unloaded guard carriers are added in frequency domain and an 2N IFFT operation is performed at a doubled sampling clock to support the time domain interpolation process afterwards.

Simulations have been performed both for one and two bits per symbol. In case of OFDM, BPSK and QPSK modulation schemes have been applied. The GFSK modulation uses a 2-FSK and a 4-FSK modulator with gaussian pulse shaping applying a time bandwidth product of BT=0.3. The modulation index h (being defined as the product of the symbol duration T and the distance of the GFSK modulated tones Δf) varies between h=0.25 and h=0.5. To ensure, that the RTZ symbol itself is a member of the ASK modulation alphabet, a modulation index of h=0.25 can only be applied to the 4-GFSK scheme.

For the simulation results, the block length is N=256, that means that in both systems one block contains 255 information symbols. The maximum length of the time invariant WSSUS channel is 16 modulation symbols and four times oversampling is applied.

Both information streams are protected by a half rated convolutional code with a memory length of 6 and a random interleaver.

In the following, the power spectral density PSD of an OFDM modulated signal and the GFSK modulated signal are compared.

FIG. 5 shows a power spectral density for 1 BPS. One advantage of OFDM is its spectral efficiency. In FIG. 5 the PSD of the BPSK modulated OFDM system is given in red. The x-axis is normalized to the bandwidth B_{OFDM} of the OFDM system, hence the main spectral components are located between −0.5 and 0.5. Spectral replicas have been eliminated using upsampling and time domain low pass filtering in the complex baseband.

This technique is not applicable in purely frequency modulated systems. In this case the transmit pulse form is the only parameter to shape the spectrum. FIG. 5 shows the PSD of the 2-GFSK with a modulation index h=0.5 in green. The bandwidth occupation is comparable, however the sidelobes of the 2-GFSK modulated signal are significantly widening the spectrum.

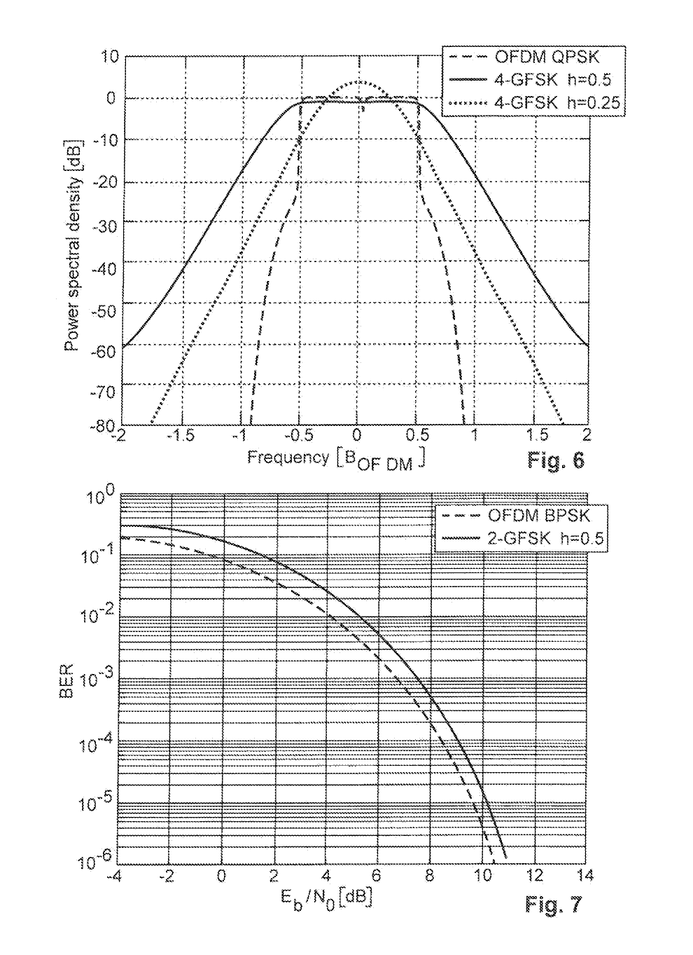

FIG. 6 shows a power spectral density for 2 bits per symbol BPS. The outstanding bandwidth efficiency of OFDM is obvious, a 4-GFSK modulated signal with a modulation index of h=0.5 (depicted in green) has almost twice the spectral occupation, and even a signal with h=0.25 has a significantly wider spectrum compared to the QPSK modulated OFDM signal. The good spectral characteristics of OFDM are provided by the time domain low pass filtering which removes the sidelobes generated from the SINC functions inside the OFDM spectrum.

In the following, the BER performance of OFDM and the GFSK modulated signal are compared. All results are gathered using Matlab performing the Monte Carlo method. For all tests an ideal synchronization and channel knowledge at the receiver side is assumed.

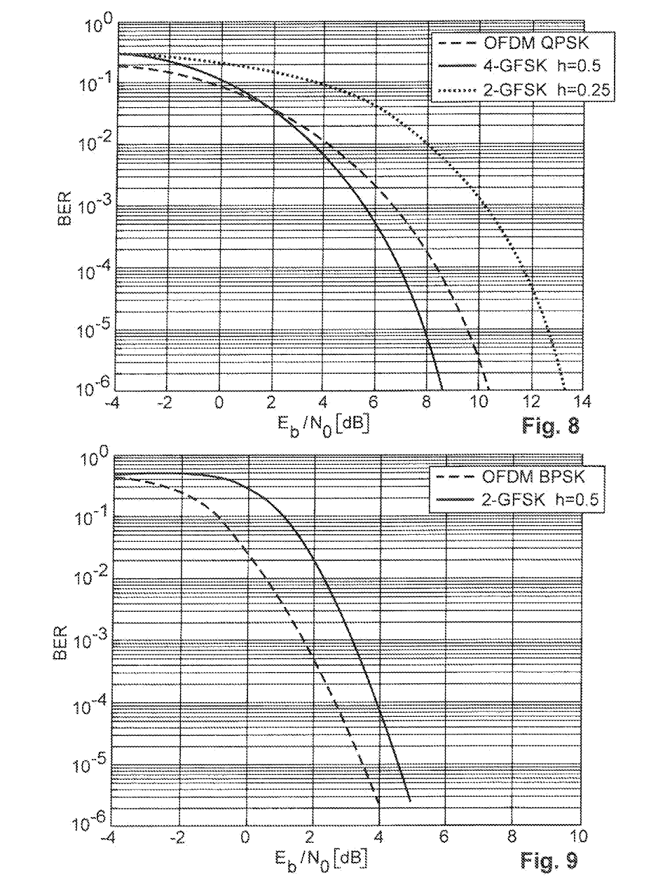

FIG. 7 shows a graph depicting the BER for an uncoded transmission with 1 BPS over an AWGN channel. The performance of the 2-GFSK scheme is only slightly worse compared to the OFDM system. In case of 2 BPS (FIG. 8) the 4-GFSK with h=0.5 outperforms the OFDM system significantly at high signal to noise (SNR) regions for the price of a larger spectral occupation. The performance of the 4-GFSK with h=0.25 is 3 dB worse than the OFDM system.

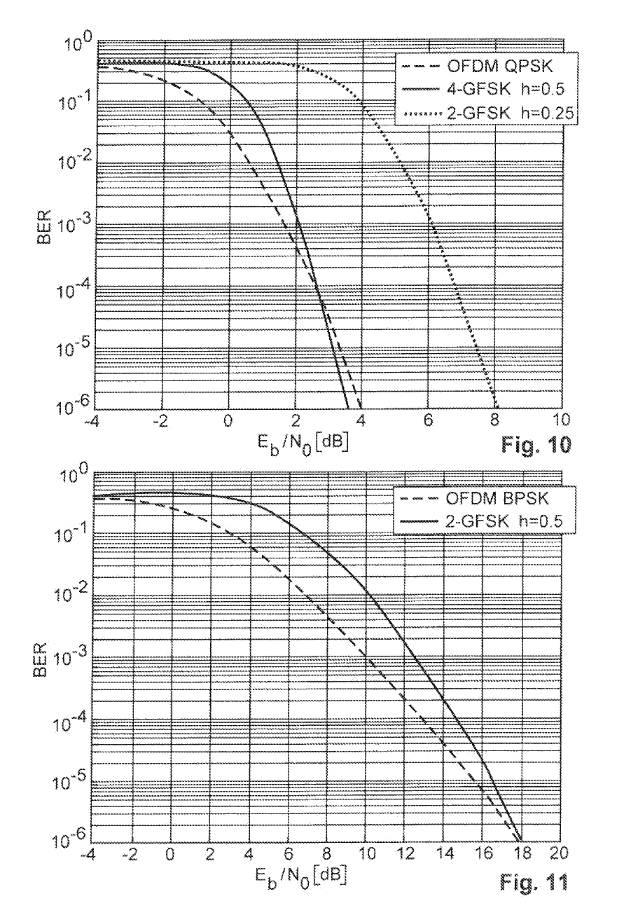

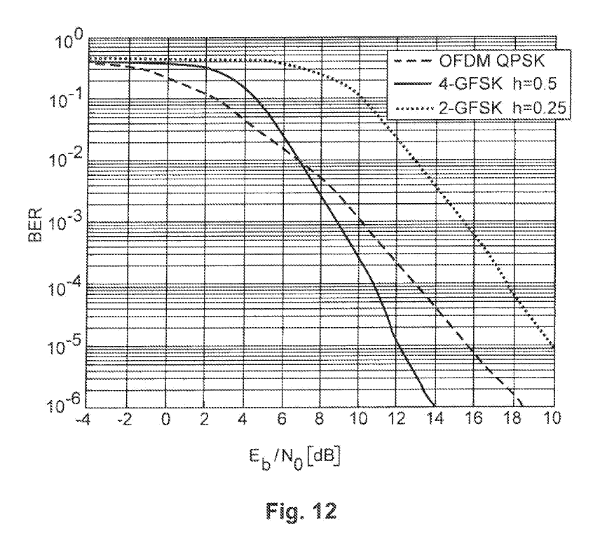

FIGS. 9 and 10 show a graph of the results for the transmission over an AWGN channel with convolutional coding enabled. While all curves have a steeper slope, the OFDM system can benefit more from coding.

The BER performance of a coded data stream transmitted over a WSSUS channel is the most significant evaluation of the equalizers capabilities.

FIG. 11 shows a graph depicting a BER performance for 1 BPS. Here, it is shown that the 2-GFSK scheme reaches the performance of the OFDM system in high SNR regions. This proofs, that the equalization being similar to an OFDM receiver can reconstruct the GFSK modulated signal in such a way, that a conventional CPM demodulator can demodulate it successfully, even when the signal was transmitted over a channel affected by multipath propagation.

For the case of 2 BPS, the 4-GFSK with h=0.5 clearly outperforms the OFDM system (again: the spectral occupation is larger). In case of h=0.25 a performance drop of 4 dB in terms of required SNR compared to the OFDM system must be accepted. Then the constant envelope advantage of the transmit signal is achievable.

According to the invention, any signal can be transmitted over a mobile radio channel with multi-path propagation and successfully equalized with an OFDM like receiver structure, as long as a cyclic prefix is included to the transmit signal in regular distances. In case of a GFSK modulation a return to zero symbol was introduced which guarantees the periodicity of the cyclic prefix even in a continuously modulated partial response CPM system.

The lower complexity of the transmitter in terms of bill of material (BOM) is a big advantage of the GFSK system over the OFDM system. Furthermore the constant envelope property allows energy and cost efficient power amplifiers.

In case of one bit per symbol the spectral occupation of the GFSK system is only slightly worse than the OFDM system and the bit error rate performance is almost equal. But the energy consumption of the 2-GFSK modulation scheme will be significantly smaller compared to the OFDM system.

TABLE I
COMPARISON OF ODFM AND GFSK FOR 2 BPS

| | |
|---|---|
| OFDM | 4-GFSK |

| | QPSK | h = 0.25 | h = 0.5 |
|---|---|---|---|
| Spectral efficiency | ++ | + | − |
| Required SNR | + | − | ++ |
| Energy efficiency | − | + | + |

To transmit two bit per symbol the GFSK needs significantly more spectral resources to be able to outperform the OFDM system. To achieve a similar spectral occupation of the GFSK signal, a 4 dB higher SNR must be used. With energy as limiting factor in many applications this SNR gap can be easily filled by more efficient power amplifiers due to the constant envelope property of the GFSK modulation scheme. Table I summarizes these results briefly.

1. A wireless communication system, comprising
a transmitter having a modulation unit for performing a frequency shift keying modulation wherein an output of the modulation unit is bundled into data blocks and a cyclic prefix adding unit for adding a cyclic prefix (CP) into each data block of an output of the modulation unit.

2. The system of claim 1, further comprising:
a receiver for receiving the data blocks transmitted by the transmitter having an equalization unit for performing a fast convolution in a frequency domain.

3. The system of claim 1, wherein each data block of the transmitter comprises a return to zero symbol (RTZ) to ensure equal phases at a start and end of each block and is extended by a cyclic prefix (CP).

4. The system of claim 3, further comprising
a receiver for receiving the data blocks transmitted by the transmitter having an equalization unit for performing a fast convolution in a frequency domain.

5. A method of wireless communication, comprising:
transmitting digital information, the digital information including audio signals, by performing a frequency shift keying modulation,
bundling the output of the frequency shift keying modulation into data blocks, and
adding a cyclic prefix into each data block of the output of the modulation.

6. The method according to claim 5, further comprising:
receiving the data blocks transmitted, and
performing a fast convolution in the frequency domain to ensure an equalization.

7. The method according to claim 5, wherein each data block to be transmitted comprises a return to zero symbol (RTZ) to ensure equal phases at a start and end of each data block and each data block is extended by a cyclic prefix (CP).

8. A method according to claim 7, further comprising:
receiving the data blocks transmitted, and
performing a fast convolution in the frequency domain to ensure an equalization.
